(19) United States
(12) Patent Application Publication
(10) Pub. No.: US 2026/0269544 A1
(43) Pub. Date: Sep. 10, 2026

(54) Leakage Protection Plug

(71) Applicant: Zhejiang Yuchuang Electronic Technology Co., Ltd., Wenzhou (CN)

(72) Inventors: Yangen CHEN, Wenzhou (CN); Jingzheng CHEN, Wenzhou (CN)

(21) Appl. No.: 19/417,166

(22) Filed: Dec. 11, 2025

(30) Foreign Application Priority Data
Mar. 10, 2025 (CN) 202520403928.8

(51) Int. Cl. H01R 13/713; H01H 83/04; H01R 103/00

(52) U.S. Cl. CPC H01R 13/7135; H01H 83/04; H01R 2103/00

(57) ABSTRACT

A leakage protection plug includes a housing, a circuit board and movable contacts disposed within the housing, a plurality of pins penetrating through a bottom of the housing, and a reset button and a test button penetrating through a top of the housing; where a middle frame is disposed within the housing, the middle frame and the plurality of pins are integrally formed by injection molding, each of the pins is provided with a connecting portion extending from an upper portion of the middle frame and connected to the circuit board, an upper portion of the pin is provided with a bent portion extending outward, and the bent portion is provided with a stationary contact aligned with the movable contact. In the leakage protection plug, the middle frame and the plurality of pins are integrally formed by injection molding. The integrated structure is more stable.

### CROSS-REFERENCE TO RELATED APPLICATIONS

The present application claims priority to Chinese Patent Application No. 202520403928.8, filed Mar. 10, 2025, the entire disclosure of which is incorporated herein by reference.

### TECHNICAL FIELD

The present disclosure relates to the technical field of plugs, and in particular to a leakage protection plug.

### BACKGROUND

Currently, many products are configured with leakage protection plugs. When an electrical appliance connected to such a plug experiences electric leakage, the leakage protection plug can automatically cut off the power supply within tens of milliseconds, thereby protecting users from electric shock hazards and ensuring their safety.

For example, Chinese Invention Patent Application No. 202323342705.5 discloses a novel leakage protection plug, including a housing, a pin assembly disposed at a bottom in the housing, a base disposed above the pin assembly, a circuit board disposed on a top surface of the base, a cross arm assembly disposed at one end in the base, a reset button assembly disposed on a top surface of the circuit board, a waterproof cover sleeved over the reset button assembly and having a test function, a tripping assembly disposed within the base, a zero-sequence current transformer disposed within the housing, two movable contacts disposed on both sides of the base, and two stationary contacts disposed on a bottom surface of the circuit board. The pin assembly includes a pin plate made of PVC materials, and a plurality of pins with one end fixed to the pin plate and the other end penetrating through the housing. In conventional leakage protection plugs, the pins are basically manually assembled into the housing, and most pins are connected to the circuit board via wires, resulting in a cumbersome assembly process. Moreover, the pins are prone to loosening, and the structural stability is insufficient.

### SUMMARY

In view of the deficiencies in the background, the technical problem to be solved by the present disclosure is to provide a leakage protection plug, which requires reduced assembly process steps and procedures and has a more stable and firmer structure.

To this end, the present disclosure is implemented by the following technical solution:

A leakage protection plug includes a housing, a circuit board and movable contacts disposed within the housing, a plurality of pins penetrating through a bottom of the housing, and a reset button and a test button penetrating through a top of the housing; where a middle frame is disposed within the housing, the middle frame and the plurality of pins are integrally formed by injection molding, each of the pins is provided with a connecting portion extending from an upper portion of the middle frame and connected to the circuit board, an upper portion of the pin is provided with a bent portion extending outward, and the bent portion is provided with a stationary contact aligned with the movable contact.

Further, a lower portion of the connecting portion is provided with a first inclined surface extending outward, the middle frame is provided with a second inclined surface that abuts against the first inclined surface, the middle frame is provided with a through hole, and the bent portion is formed by bending the pin outward through the through hole.

Further, the reset button and the test button are integrally connected by a film disposed within the housing, a button supporting member configured to support the film is disposed within the housing, and the button supporting member is fixedly connected to the housing by ultrasonic welding.

Further, both sides of the middle frame are provided with a plurality of limiting clips, and the circuit board is insertable into the limiting clips.

Further, the housing includes an upper housing and a lower housing, which are detachably connected by a plurality of bolts.

Further, a number of the pins is two.

By adopting the above technical solution, the middle frame and the plurality of pins are integrally formed by injection molding, each of the pins is provided with a connecting portion extending from the upper portion of the middle frame and connected to the circuit board, and the upper portion of the pin is provided with the bent portion extending outward. The integrated structure is more stable and firmer, and assembly process steps and procedures are reduced, thereby facilitating automated assembly production.

### BRIEF DESCRIPTION OF THE DRAWINGS

The present disclosure has the following figures:

FIG. 1 is a perspective structural view of the present disclosure.

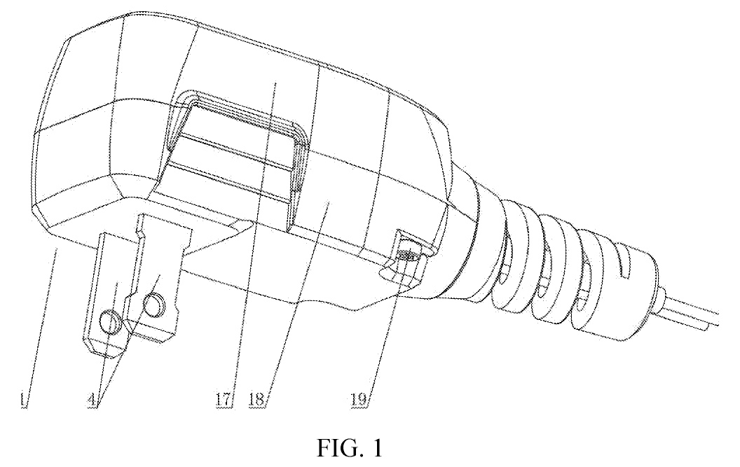

FIG. 2 illustrates an internal structure of a housing of the present disclosure.

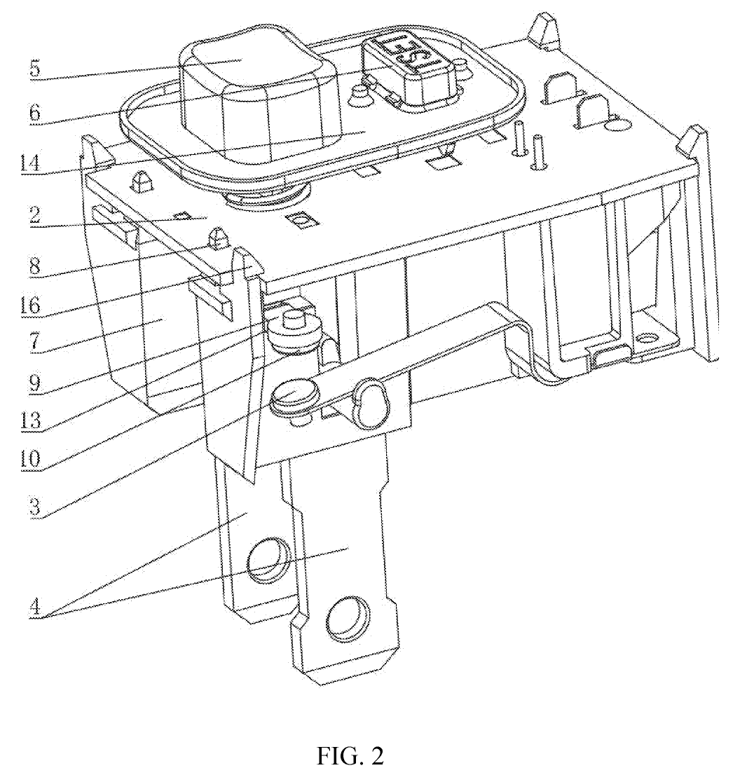

FIG. 3 is a sectional view of the present disclosure.

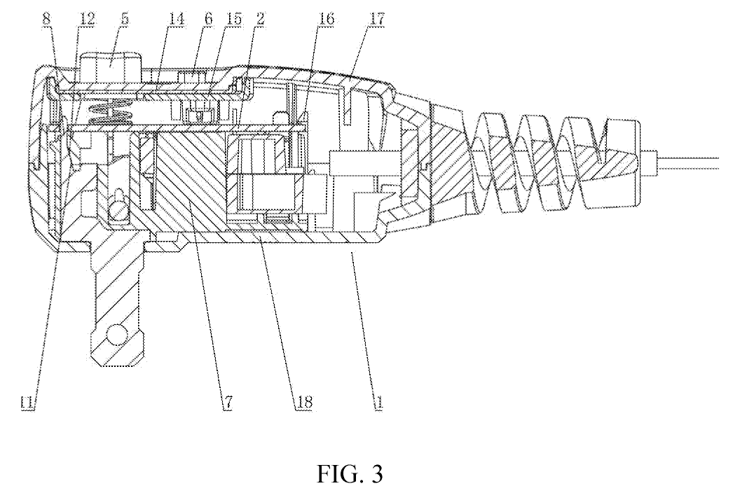

Reference numerals: 1-housing; 2-circuit board; 3-movable contact; 4-pin; 5-reset button; 6-test button; 7-middle frame; 8-connecting portion; 9-bent portion; 10-stationary contact; 11-first inclined surface; 12-second inclined surface; 13-through hole; 14-film; 15-button supporting member; 16-limiting clip; 17-upper housing; 18-lower housing; and 19-bolt.

### DETAILED DESCRIPTIONS OF THE EMBODIMENTS

To further elaborate on the technical means employed by the present disclosure to achieve the intended objectives and the resultant efficacy, the specific implementations, structures, features, and functions of the present disclosure will be described below in detail in combination with the drawings and preferred embodiments.

Referring to the above figures, a leakage protection plug provided by the present disclosure includes a housing 1, a circuit board 2 and movable contacts 3 disposed within the housing 1, a plurality of pins 4 penetrating through a bottom of the housing 1, and a reset button 5 and a test button 6 penetrating from a top of the housing 1; where a middle frame 7 is disposed within the housing 1, the middle frame 7 and the plurality of pins 4 are integrally formed by injection molding, each of the pins 4 is provided with a connecting portion 8 extending from an upper portion of the middle frame 7 and connected to the circuit board 2, an upper portion of the pin 4 is provided with a bent portion 9 extending outward, and the bent portion 9 is provided with a stationary contact 10 aligned with the movable contact 3; a lower portion of the connecting portion 8 is provided with a first inclined surface 11 extending outward, the middle frame 7 is provided with a second inclined surface 12 that abuts against the first inclined surface 11, the middle frame 7 is provided with a through hole 13, and the bent portion 9 is formed by bending the pin 4 outward through the through hole 13; the reset button 5 and the test button 6 are integrally connected by a film 14 disposed within the housing 1, a button supporting member 15 configured to support the film 14 is disposed within the housing 1, and the button supporting member 15 is fixedly connected to the housing 1 by ultrasonic welding; both sides of the middle frame 7 are provided with a plurality of limiting clips 16, and the circuit board 2 is insertable into the limiting clips 16; the housing 1 includes an upper housing 17 and a lower housing 18, which are detachably connected by a plurality of bolts 19; and a number of the pins 4 is two.

In this embodiment, the middle frame 7 and the plurality of pins 4 are integrally formed by injection molding. The integrated structure is more stable and firmer, and assembly process steps and procedures are reduced, thereby facilitating automated assembly production. The connecting portion 8 is configured to connect to the circuit board 2, and the bent portion 9 is configured to dispose the stationary contact 10. Provision of the first inclined surface 11 and the second inclined surface 12 restricts upward movement of the connecting portion 8 and the pins 4 relative to the middle frame 7, and the bent portion 9 is formed by bending the pin 4 outward through the through hole 13, which restricts downward movement of the bent portion 9 and the pins 4 relative to the middle frame 7, thereby effectively preventing loosening of the pins 4. Provision of the button supporting member 15 and the film 14 prevents liquid from entering the interior of the housing 1 through gaps between the reset button 5, the test button 6, and the housing 1, thereby improving safety. The circuit board 2 is fixed by being inserted into the limiting clips 16 on both sides of the middle frame 7, resulting in a high structural stability.

The above descriptions are only the preferred embodiments of the present disclosure, and should not be construed as a limitation to the present disclosure in any form. Although the present disclosure has been disclosed through the preferred embodiments, such disclosure is not intended to limit the present disclosure. Any person skilled in the art may, without departing from the technical solution scope of the present disclosure, make numerous alterations or modifications to the disclosed technical contents to obtain equivalent embodiments of equivalent variations. Any simple change, equivalent variation, or modification, made to the above embodiments according to the technical essence of the present disclosure without departing from the contents of the technical solution of the present disclosure, should fall within the protection scope of the technical solution of the present disclosure.

What is claimed is:

1. A leakage protection plug, comprising a housing, a circuit board and movable contacts disposed within the housing, a plurality of pins penetrating through a bottom of the housing, and a reset button and a test button protruding from a top of the housing; wherein a middle frame is disposed within the housing, the middle frame and the plurality of pins are integrally formed by injection molding, each of the pins is provided with a connecting portion extending from an upper portion of the middle frame and connected to the circuit board, an upper portion of the pin is provided with a bent portion extending outward, and the bent portion is provided with a stationary contact aligned with the movable contact.

2. The leakage protection plug according to claim 1, wherein a lower portion of the connecting portion is provided with a first inclined surface extending outward, the middle frame is provided with a second inclined surface that abuts against the first inclined surface, the middle frame is provided with a through hole, and the bent portion is formed by bending the pin outward through the through hole.

3. The leakage protection plug according to claim 2, wherein the reset button and the test button are integrally connected by a film disposed within the housing, a button supporting member configured to support the film is disposed within the housing, and the button supporting member is fixedly connected to the housing by ultrasonic welding.

4. The leakage protection plug according to claim 3, wherein both sides of the middle frame are provided with a plurality of limiting clips, and the circuit board is insertable into the limiting clips.

5. The leakage protection plug according to claim 3, wherein the housing comprises an upper housing and a lower housing, which are detachably connected by a plurality of bolts.

6. The leakage protection plug according to claim 3, wherein a number of the pins is two.
